(19) United States
(12) Patent Application Publication
(10) Pub. No.: US 2005/0091829 A1
(43) Pub. Date: May 5, 2005

(54) Bushing for supporting shaft and shaft assembling method using the same

(75) Inventors: Young-min Yoon, Yongin-si (KR); Byeong-hwa Ahn, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/926,948

(22) Filed: Aug. 27, 2004

(30) Foreign Application Priority Data
Oct. 30, 2003 (KR) 2003-76235

(51) Int. Cl. B23P 11/00; B21D 39/00; F16C 33/02

(52) U.S. Cl. 29/509; 29/505; 384/295

(57) ABSTRACT

A shaft support bushing with an improved structure, and a method of combining a bushing with a bracket. The bushing includes: a body having a coupling hole through which the shaft is inserted and being fitted into an installation hole of the bracket; a flange extending from one end of the body over a part of the bracket; and a skirt portion formed on the other end of the body to prevent the body from separating from the installation hole. The shaft assembling method includes: forming an installation hole in a bracket; coupling a bushing into the installation hole, the bushing comprised of a body, which has a coupling hole into which a shaft is inserted, and a flange extending from one end of the body over a part of the bracket; pressing the other end of the body to form a skirt portion preventing the bushing from separating from the bracket; and coupling the shaft into the installation hole.

### CROSS-REFERENCE TO RELATED APPLICATION

This application claims the priority of Korean Patent Application No. 2003-76235, filed on Oct. 30, 2003, in the Korean Intellectual Property Office, the disclosure of which is incorporated herein in its entirety by reference.

### BACKGROUND OF THE INVENTION

1. Field of the Invention

The present invention relates to a bushing that rotatably supports a shaft against a bracket and a shaft assembling method using the bushing, and, more particularly, to a bushing with an improved structure that is not separated from a bracket before a shaft is assembled, and a shaft assembling method using the bushing.

2. Description of the Related Art

In general, printers, copy machine, etc., include a plurality of units that may be rotated by a force transmitted from a driving source. Each of the units is mounted to a bracket using a shaft and engages a gear between the driving source and the shaft so that a driving force is transmitted thereto from the driving source. A bushing is interposed between the bracket and the shaft to rotatably support the shaft.

FIG. 1 is an exploded perspective view illustrating a conventional structure of a shaft assembled to a pair of brackets. FIG. 2 is an exploded perspective view illustrating a conventional structure of a bracket and a bushing supporting a shaft.

As shown in FIGS. 1 and 2, each bracket 11 has a plurality of installation holes 13 to which a plurality of shafts 15 are respectively inserted thereinto. A bushing 20, which may rotatably support a shaft 15, is interposed between each of the installation holes 13 and the corresponding shaft 15. The bushing 20 prevents vibrations and abrasion of the shaft 15 when the shaft 15 is rotated.

The bushing 20 includes a body 21 and a flange 23. The body 21 is inserted into an installation hole 13 of the bracket 11 and has a coupling hole 21a to receive the shaft 15. The flange 23 is a protrusion formed around one end of the body 21 and has a diameter that is larger than the installation hole 13.

The body 21 has a D-cut portion 21b to prevent rotating of the bushing 20 coupled to the bracket 11. The installation hole 13 has a shape that corresponds to an outer circumference of the body 21.

A process of coupling the shaft 15 to the bracket 11 using the bushing 20 having the structure described above will now be described.

Initially, the bracket 11, having the installation holes 13 at predetermined positions, is prepared. The bushing 20 is coupled to each of the shafts 15. In this state, the bushing 20 coupled to each of the shafts 15 is rotatable so that the positions of the D-cut portions 21b of the plurality of the bushings 20 are not aligned with each other.

The shaft 15 coupled to the bushing 20 is inserted into the installation hole 13. However, when the shaft 15 is inserted into the installation hole 13 in the above-described order, the shaft 15 is not level. Furthermore, the D-cut portion 21b of the bushing 20 may not match a corresponding portion of the installation hole 13. Therefore, prior to assembling the bushings 20 to the installation holes 13, a worker is required to rotate each of the bushings 20 using, for example, tweezers, such that the bushings 20 are aligned with the installation holes 13. This process is time consuming, lowers productivity, and raises costs.

### SUMMARY OF THE INVENTION

The present invention provides a bushing with an improved structure that is not separated from a bracket before a shaft is assembled, and a shaft assembling method using the bushing.

According to an aspect of the present invention, a bushing that rotatably supports a shaft against a bracket comprises a body having a coupling hole through which the shaft is inserted and being fitted into an installation hole of the bracket; a flange extending from one end of the body over a part of the bracket; and a skirt portion formed on the other end of the body to prevent the body from separating from the installation hole.

According to another aspect of the present invention, a shaft assembling method comprises forming an installation hole in a bracket; coupling a bushing into the installation hole, the bushing including a body, which has a coupling hole into which a shaft is inserted, and a flange extending from one end of the body over a part of the bracket; pressing the other end of the body to form a skirt portion preventing the bushing from separating from the bracket; and coupling the shaft into the installation hole.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a conventional structure of a shaft assembled to a pair of brackets;

FIG. 2 is an exploded perspective view illustrating a conventional structure of a bracket and a bushing supporting a shaft;

FIG. 3 is a perspective view of a bushing for supporting a shaft according to an embodiment of the present invention;

FIG. 4 is a sectional view illustrating the bushing of FIG. 3 coupled to a bracket;

FIG. 5 is an exploded perspective view for explaining a method of assembling a shaft using the bushing of FIG. 3 according to an embodiment of the present invention;

FIG. 6 is a perspective view of a bushing for supporting a shaft according to another embodiment of the present invention; and

FIG. 7 is a sectional view illustrating the bushing of FIG. 6 coupled to a bracket.

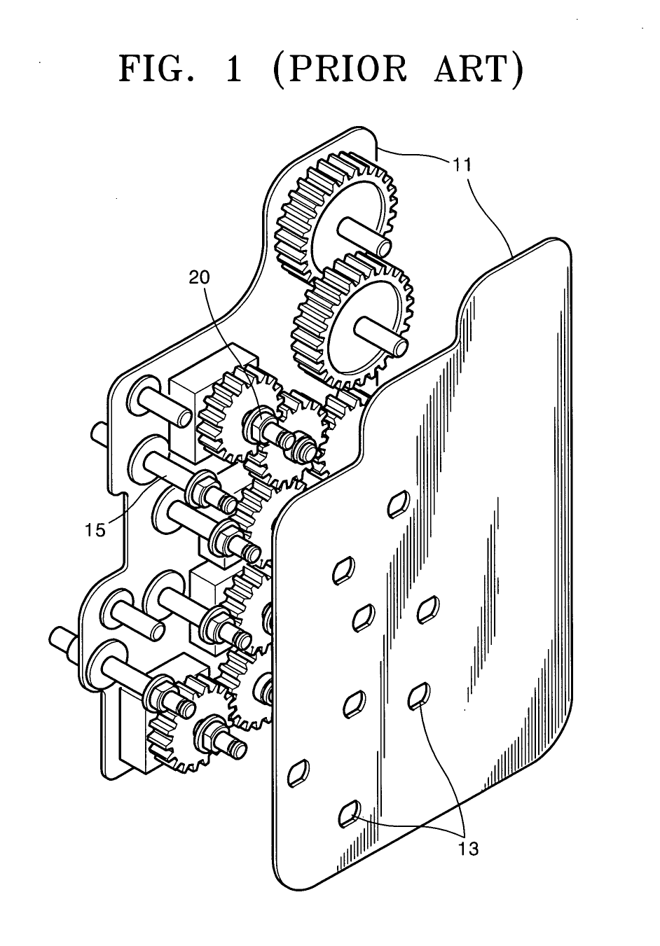

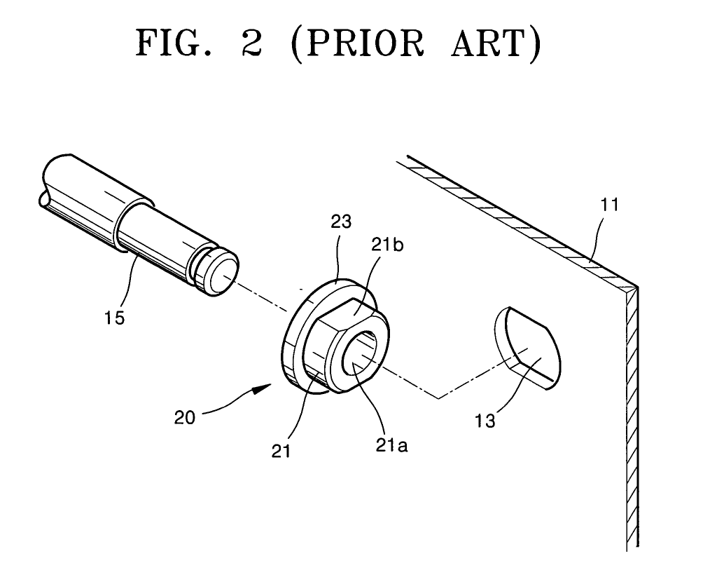

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Embodiments of a bushing to support a shaft and a shaft assembling method using the same according to the present invention will be described in detail with reference to the appended drawings.

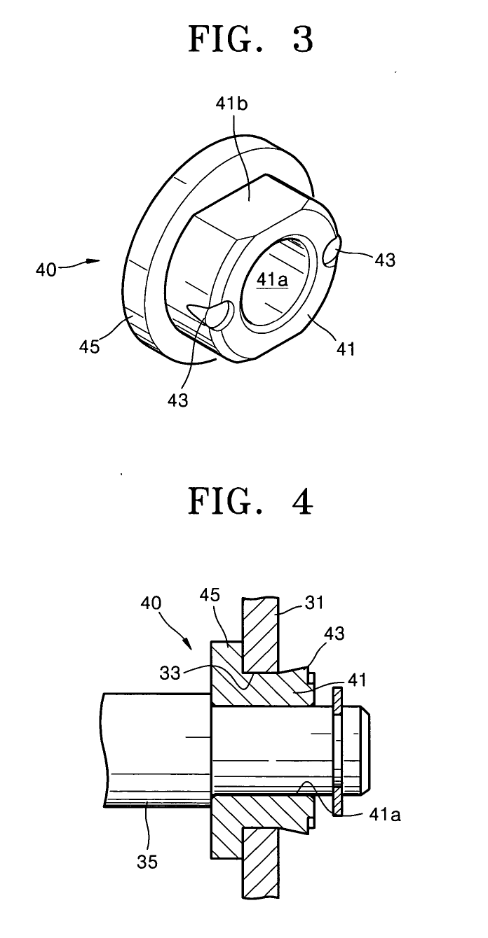

Referring to FIGS. 3 and 4, a bushing 40 according to an embodiment of the present invention supports a shaft 35 such that the shaft 35 may be rotated in a bracket 31. In particular, the bracket 31 has a plurality of installation holes 33, and the shaft 35 is inserted into each of the installation holes 33, wherein the bushing 40 is interposed between the shaft 35 and the installation hole 33.

The bushing 40 includes a body 41, a flange 45, and a skirt portion 43, which prevents separation of the bushing 40 from the bracket 31. The body 41, which is fitted into the installation hole 33, has a coupling hole 41a into which the shaft 35 is inserted. The flange 45 extends over a part of an inner surface of the bracket 31 to prevent the body 41 from separating from the bracket 31.

The skirt portion 43 is formed on the other end of the body 41 to prevent the bushing 40 from separating from the bracket 40 before the shaft 35 is inserted into the bracket 40. The skirt portion 43 is formed after the body 41 has been coupled to the installation hole 33. In particular, after the body 41 is coupled to the bracket 31, an end of the body 41 opposite to the flange 45 is partially pressed using, for example, a press machine, such that the end has a larger circumference than the installation hole 33, thereby resulting in the skirt portion 43.

A spinning preventing portion 41b is formed on the body 41 to prevent spinning of the bushing in the installation hole 33. To this end, the installation hole 33 has a shape corresponding to the spinning preventing portion 41b. For example, the spinning preventing portion 41b may have a D-cut shape, as illustrated in FIG. 3.

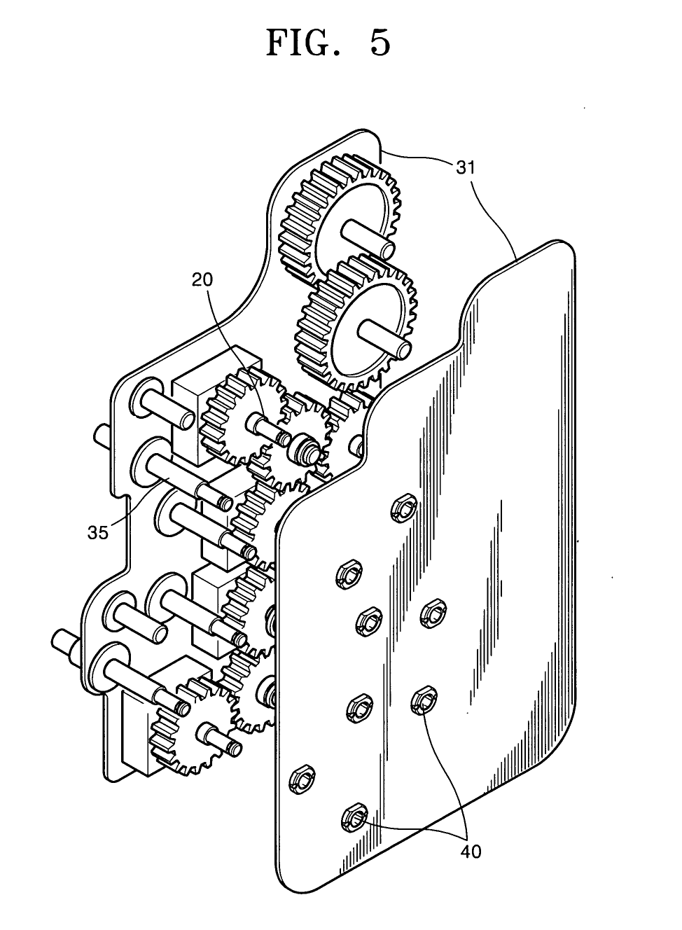

A method of assembling a shaft using the bushing according to an embodiment of the present invention will be described with reference to FIGS. 4 and 5.

Initially, a plurality of installation holes 33 are formed in the bracket 31. The bushing 40 including the body 41, which has the coupling hole 41a into which the shaft 35 is inserted, and the flange 45 extending from one end of the body 41 over a part of the bracket 31, is prepared. Optionally, the spinning preventing portion 41b may be formed on the outer circumference of the body 41 to prevent spinning of the bushing 40 in the installation hole 33.

Next, the bushing 40 is coupled to each of the installation holes 33 and the skirt portion 43 is formed by pressing the other end of the bushing 40 opposite to the flange 45 using, for example, press machine, such that the other end of the bushing 40 has a larger circumference than the installation hole 33. Then, the shaft 35 is inserted into the coupling hole 41a.

By forming the skirt portion 43 in the bushing 40 as described above, separation of the bushing 40 from the bracket 31 may be prevented even when the shaft 35 is not coupled yet to the bushing 40.

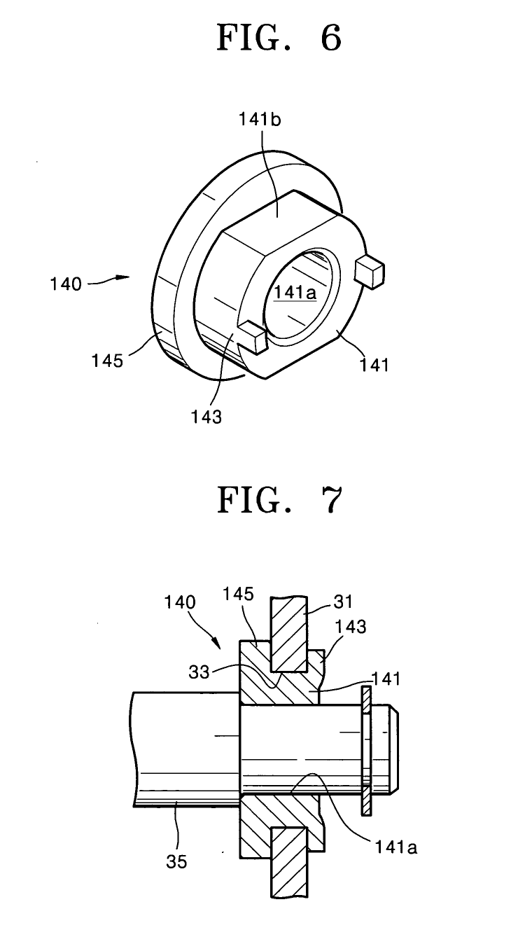

Referring to FIGS. 6 and 7, a bushing 140 according to another embodiment of the present invention includes a body 141 having a coupling hole 141a, a flange 145, and a skirt portion 143. The structures of the body 141 and the flange 145 are substantially the same as the structures of the body 41 and the flange 45 shown in FIGS. 3 and 4, and thus detailed descriptions thereof will be omitted.

The skirt portion 143 is formed on an end of the body 141 opposite to the flange 145 to prevent separation of the bushing 140 from the bracket 31 when the shaft 35 is not inserted into the body 41. The skirt portion 143 is formed as a result of the body 41, which is inserted into the installation hole 33, being bent into a shape, illustrated in FIG. 7. As a result, a separation of the bushing 140 from the bracket 31 is prevented. Although only two skirt portions 143 are formed in the embodiment illustrated in FIGS. 6 and 7, the present invention is not limited to this structure, and more than two skirt portions 143 may be formed.

A spinning preventing portion 141b is formed on the body 141 to prevent spinning of the bushing 140 in the installation hole 33. The installation hole 33 may have a shape corresponding to the spinning preventing portion 141b. For example, the spinning preventing portion 141b may have a D-cut shape, as illustrated in FIG. 6.

As is described above, a bushing to support a shaft according to the present invention may be tightly coupled to a bracket before the bracket is coupled with the shaft. Therefore, when coupling a plurality of shafts to a bracket, no additional process of fixing bushings in place is required so that the number of assembling processes, the working time, and the manufacturing cost are reduced.

Although a few embodiments of the present invention have been shown and described, it would be appreciated by those skilled in the art that changes may be made in these embodiments without departing from the principles and spirit of the invention, the scope of which is defined in the claims and their equivalents.

1. A bushing that rotatably supports a shaft against a bracket, the bushing comprising:
a body having a coupling hole through which the shaft is inserted and being fitted into an installation hole of the bracket;
a flange extending from one end of the body over a part of the bracket; and
a skirt portion formed on the other end of the body to prevent the body from separating from the installation hole.

2. The bushing of claim 1, wherein the skirt portion is formed by pressing the body inserted into the installation hole such that the other end of the body has a larger circumference than the installation hole.

3. The bushing of claim 2, further comprising a spinning preventing portion formed on the body to prevent spinning of the bushing in the installation hole of the bracket.

4. The bushing of claim 1, wherein the skirt portion is formed as a result of the other end of the body, inserted into the installation hole of the bracket, being bent such that separation of the body from the installation hole is prevented.

5. The bushing of claim 4, further comprising a spinning preventing portion formed on the body to prevent spinning of the bushing in the installation hole of the bracket.

6. The bushing of claim 1, further comprising a spinning preventing portion formed on the body to prevent spinning of the bushing in the installation hole of the bracket.

7. A shaft assembling method comprising:
forming an installation hole in a bracket;
coupling a bushing into the installation hole, the bushing including a body, which has a coupling hole into which a shaft is inserted, and a flange extending from one end of the body over a part of the bracket;
pressing the other end of the body to form a skirt portion preventing the bushing from separating from the bracket; and
coupling the shaft into the installation hole.

8. The shaft assembling method of claim 7, further comprising forming a spinning preventing portion on the body to prevent spinning of the bushing in the installation hole.

9. A bushing to rotatably support a shaft against a bracket, the shaft extending from an interior of the bracket to be at least coplanar with the bracket, the bracket having an installation hole, and the bushing comprising:
a body, having a coupling hole through which the shaft is inserted, to fit into the installation hole of the bracket from the interior of the bracket to the exterior of the bracket;
a flange extending from a first portion of the body, which is interior of the bracket, over the bracket; and
a skirt portion formed on a second portion of the body, which is exterior of the bracket, to prevent the body from separating from the installation hole.

10. The bushing according to claim 9, wherein the skirt portion is formed after the body is fit into the installation hole of the bracket.

11. The bushing according to claim 9, wherein the skirt portion is formed by pressing the second portion of the body such that an end of the body has a larger circumference than the installation hole.

12. The bushing according to claim 11, further comprising a spinning preventing portion formed on the body to prevent spinning of the bushing in the installation hole of the bracket.

13. The bushing according to claim 9, wherein the skirt portion is formed as a result of the second end of the body, inserted into the installation hole of the bracket, being bent.

14. The bushing according to claim 13, further comprising a spinning preventing portion formed on the body to prevent spinning of the bushing in the installation hole of the bracket.

15. The bushing according to claim 9, further comprising a spinning preventing portion formed on the body to prevent spinning of the bushing in the installation hole of the bracket.

16. A method of combining a shaft with a bracket, comprising:
forming an installation hole in the bracket;
forming a bushing from a body having first and second ends by inserting a shaft into a coupling hole of the body from the first end to the second end, the body including a flange extending from the first end of the body;
coupling the bushing with the installation hole of the bracket;
pressing the second end of the body to form a skirt portion so as to cooperate with the flange to prevent the bushing from separating from the bracket; and
coupling the shaft into the installation hole.

17. The method according to claim 16, further comprising forming a spinning prevention portion on the body to prevent spinning of the bushing in the installation hole.

18. A method of combining a shaft with a bracket, comprising:
forming an installation hole in the bracket;
forming a bushing from a body having first and second ends by inserting the shaft into a coupling hole of the body from the first end to the second end, the body including a flange extending from the first end of the body;
coupling the bushing with the installation hole of the bracket;
bending the second end of the body to form a bent portion so as to cooperate with the flange to prevent the bushing from separating from the bracket; and
coupling the shaft into the installation hole.

19. The method according to claim 18, further comprising forming a spinning prevention portion on he body to prevent spinning of the bushing in the installation hole.
